(19) United States
(12) Patent Application Publication
(10) Pub. No.: US 2024/0154681 A1
(43) Pub. Date: May 9, 2024

(54) CONTROLLING OVER-THE-AIR BEAMFORMING CALIBRATION

(71) Applicant: Telefonaktiebolaget LM Ericsson (publ), Stockholm (SE)

(72) Inventors: Joao Vieira, Hjärup (SE); Pål Frenger, Linköping (SE); Vijay Venkateswaran, Västerås (SE)

(21) Appl. No.: 18/548,953

(22) PCT Filed: Mar. 4, 2021
(86) PCT No.: PCT/EP2021/055497

§ 371 Date: Sep. 5, 2023

(51) Int. Cl. H04B 7/06; H04B 7/0413

(52) U.S. Cl. CPC H04B 7/0696; H04B 7/0413

(57) ABSTRACT

A method of controlling over-the-air beamforming calibration for a multi-antenna transceiver system having a plurality of beamforming sub-systems connected to respective transceiver chains, wherein each beamforming sub-system is included in an access point of a distributed multiple-input multiple-output (MIMO) system, and wherein each beamforming sub-system is associated with a set of available beams. The method includes selecting pairs of one transmission beam and one reception beam, wherein a pair of the one transmission beam and the one reception beam are selected from the set of available beams of different ones of the beamforming sub-systems, and instructing the beamforming sub-systems to use each selected pair of one transmission beam and one reception beam for sounding signal measurements in a respective measurement resource.

### TECHNICAL FIELD

The present disclosure relates generally to the field of wireless communication. More particularly, it relates to beamforming calibration for a multi-antenna transceiver system.

### BACKGROUND

There exist various approaches for beamforming calibration of a multi-antenna transceiver system. A first group of such approaches involves using an internal calibration network in a multi-antenna transceiver device, and a second group of such approaches involves over-the-air signaling.

Approaches involving use of an internal calibration network typically entails high complexity in terms of hardware and/or software. Furthermore, such approaches are not suitable for distributed multi-antenna transceiver systems.

Approaches involving over-the-air signaling typically entails signaling overhead. Furthermore, it may be cumbersome to apply existing over-the-air signaling methods suited for beamforming calibration of co-located multi-antenna systems to beamforming calibration of distributed multi-antenna transceiver systems comprising analog, or hybrid, beamforming sub-systems.

There is a need for approaches for beamforming calibration of a multi-antenna transceiver system.

Preferably, such approaches have one or more of the following advantages: requiring less signaling overhead than over-the-air signaling approaches of the prior art, being suitable for distributed multi-antenna transceiver systems, being suitable for multi-antenna transceiver systems comprising analog/hybrid beamforming sub-systems, and scaling well (e.g., in terms of slowly growing overhead) when the number of beamforming sub-systems increases.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method of controlling over-the-air beamforming calibration for a multi-antenna transceiver system having a plurality of beamforming sub-systems connected to respective transceiver chains, wherein each beamforming sub-system is comprised in an access point of a distributed multiple-input multiple-output (MIMO) system, and wherein each beamforming sub-system is associated with a set of available beams.

The method comprises selecting pairs of one transmission beam and one reception beam, wherein the beams of a pair are selected from the set of available beams of different ones of the beamforming sub-systems, and instructing the beamforming sub-systems to use each selected pair of one transmission beam and one reception beam for sounding signal measurements in a respective measurement resource.

In some embodiments, selecting pairs of one transmission beam and one reception beam comprises selecting all possible pairs for the plurality of beamforming sub-systems.

In some embodiments, selecting pairs of one transmission beam and one reception beam comprises selecting less than all possible pairs for the plurality of beamforming sub-systems.

In some embodiments, the selected pairs comprise at least one transmission beam per beamforming sub-system.

In some embodiments, the selected pairs comprise at least one reception beam per beamforming sub-system for each selected transmission beam.

In some embodiments, the selected pairs comprise beam pairs previously providing sounding signal measurements that meet a first measurement quality criterion.

In some embodiments, selecting pairs of one transmission beam and one reception beam comprises selecting a first set of pairs and selecting at least a second set of pairs, and instructing the beamforming sub-systems comprises instructing the beamforming sub-systems to use each selected pair of the first set for sounding signal measurements in a collection of first respective measurement resources and instructing the beamforming sub-systems to use each selected pair of the second set for sounding signal measurements in a collection of second respective measurement resources, wherein the collection of second respective measurement resources occurs later in time than the collection of first respective measurement resources.

In some embodiments, beams of the first set of pairs are wider than beams of the second set of pairs.

In some embodiments, the method further comprises acquiring measurement reports from the beamforming sub-systems, wherein the measurement reports indicate quality of the sounding signal measurements.

In some embodiments, the method further comprises discontinuing the sounding signal measurements when the sounding signal measurements meet a second measurement quality criterion for all beamforming sub-systems.

In some embodiments, the method further comprises determining respective beamforming calibration factors for the transceiver chains based on the sounding signal measurements.

In some embodiments, the method further comprises instructing one or more of the beamforming sub-systems to transmit a beamformed communication signal based on reverse channel estimation and the determined beamforming calibration factors.

In some embodiments, each beamforming calibration factor represents a ratio between receiver path gain and transmitter path gain for a corresponding transceiver chain or a ratio between transmitter path gain and receiver path gain for a corresponding transceiver chain.

In some embodiments, determining respective beamforming calibration factors comprises performing joint iterative minimization, wherein each iteration comprises updating estimates for the beamforming calibration factors based on a calibration nuisance estimate of a previous iteration, and updating the calibration nuisance estimate based on the updated estimates for the beamforming calibration factors.

In some embodiments, the over-the-air beamforming calibration is for providing a calibrated baseband-to-baseband channel which is closer to reciprocal with an un-calibrated baseband-to-baseband opposite direction channel than an un-calibrated baseband-to-baseband channel is.

In some embodiments, each beamforming sub-system is connected to a number of transceiver chains, wherein the number of transceiver chains is less than a number of antenna elements of the beamforming sub-system.

In some embodiments, each beamforming sub-system is connected to a single transceiver chain.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is an apparatus configured to control over-the-air beamforming calibration for a multi-antenna transceiver system having a plurality of beamforming sub-systems connected to respective transceiver chains, wherein each beamforming sub-system is comprised in an access point of a distributed multiple-input multiple-output (MIMO) system, and wherein each beamforming sub-system is associated with a set of available beams.

The apparatus comprises controlling circuitry configured to cause selection of pairs of one transmission beam and one reception beam, wherein the beams of a pair are selected from the set of available beams of different ones of the beamforming sub-systems, and instruction of the beamforming sub-systems to use each selected pair of one transmission beam and one reception beam for sounding signal measurements in a respective measurement resource.

A fourth aspect is an apparatus configured to control over-the-air beamforming calibration for a multi-antenna transceiver system having a plurality of beamforming sub-systems connected to respective transceiver chains, wherein each beamforming sub-system is comprised in an access point of a distributed multiple-input multiple-output (MIMO) system, and wherein each beamforming sub-system is associated with a set of available beams.

The apparatus comprises a selector configured to select pairs of one transmission beam and one reception beam, wherein the beams of a pair are selected from the set of available beams of different ones of the beamforming sub-systems.

The apparatus comprises an instructor configured to instruct the beamforming sub-systems to use each selected pair of one transmission beam and one reception beam for sounding signal measurements in a respective measurement resource.

A fifth aspect is a control device for a multi-antenna transceiver system comprising the apparatus of any of the third and fourth aspects.

A sixth aspect is a multi-antenna transceiver system comprising the apparatus of any of the third and fourth aspects and/or the control device of the fifth aspect.

In some embodiments, the multi-antenna transceiver system further comprises the plurality of beamforming sub-systems and/or the respective transceiver chains.

In some embodiments, the multi-antenna transceiver system is a distributed multiple-input multiple-output, MIMO, system.

In some embodiments, any of the above aspects may additionally have features identical with or corresponding to any of the various features as explained above for any of the other aspects.

An advantage of some embodiments is that approaches are provided for beamforming calibration of a multi-antenna transceiver system.

An advantage of some embodiments is that the amount of signaling overhead due to over-the-air calibration signaling is adjustable (e.g., can be reduced compared to other approaches).

An advantage of some embodiments is that the amount of signaling overhead due to over-the-air calibration signaling is reduced compared to over-the-air signaling approaches of the prior art.

An advantage of some embodiments is that a trade-off possibility is provided between calibration accuracy and the amount of signaling overhead due to over-the-air calibration signaling.

An advantage of some embodiments is that they are suitable for distributed multi-antenna transceiver systems.

An advantage of some embodiments is that they are suitable for multi-antenna transceiver systems comprising analog/hybrid beamforming sub-systems.

An advantage of some embodiments is that approaches are provided which scales well when the number of beamforming sub-systems increases.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a flowchart illustrating example method steps according to some embodiments;

FIG. 2 is a signaling diagram illustrating example signaling according to some embodiments;

FIG. 3 is a collection of schematic drawings illustrating example channels and beamforming in relation to some embodiments;

FIG. 4 is a collection of schematic drawings illustrating example sounding approaches according to some embodiments;

FIG. 5 is a schematic block diagram illustrating an example system comprising an example apparatus according to some embodiments;

FIG. 6 is a schematic block diagram illustrating an example scenario in relation to some embodiments;

FIG. 7 is a simulation plot illustrating example results achievable by some embodiments; and

FIG. 8 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

In the following, embodiments will be described where approaches are provided for beamforming calibration of a multi-antenna transceiver system; more particularly for controlling over-the-air beamforming calibration for a multi-antenna transceiver system.

Generally, beamforming calibration comprises determining respective beamforming calibration factors for the transceiver chains of a multi-antenna transceiver system. Typically, each transceiver chain comprises a transmitter chain and a receiver chain.

Some embodiments relates to situations where each beamforming calibration factor represents a ratio between receiver path gain and transmitter path gain for a corresponding transceiver chain, or a ratio between transmitter path gain and receiver path gain for a corresponding transceiver chain. Such situations may occur, for example, in scenarios where channel reciprocity is desirable.

Thus, in some embodiments, the beamforming calibration is for providing a calibrated baseband-to-baseband channel which is closer to reciprocal with an un-calibrated baseband-to-baseband opposite direction channel than an un-calibrated baseband-to-baseband channel is.

An advantage of some embodiments is that approaches are provided for beamforming calibration of a multi-antenna transceiver system.

An advantage of some embodiments is that the amount of signaling overhead due to over-the-air calibration signaling is adjustable (e.g., can be reduced compared to other approaches).

An advantage of some embodiments is that the amount of signaling overhead due to over-the-air calibration signaling is reduced compared to over-the-air signaling approaches of the prior art.

An advantage of some embodiments is that a trade-off possibility is provided between calibration accuracy and the amount of signaling overhead due to over-the-air calibration signaling.

An advantage of some embodiments is that they are suitable for distributed multi-antenna transceiver systems.

An advantage of some embodiments is that they are suitable for multi-antenna transceiver systems comprising analog/hybrid beamforming sub-systems.

An advantage of some embodiments is that approaches are provided which scales well when the number of beamforming sub-systems increases.

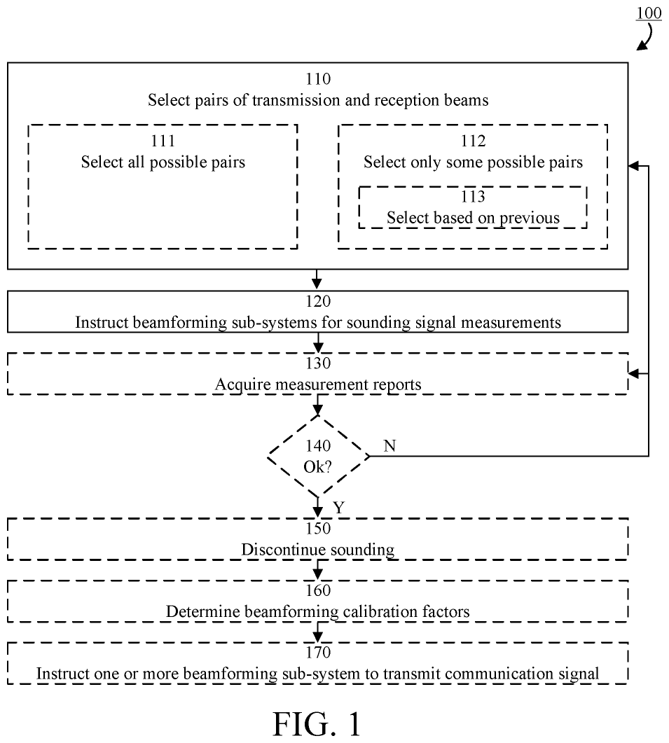

FIG. 1 illustrates an example method 100 according to some embodiments. The method 100 is for controlling over-the-air (OTA) beamforming calibration for a multi-antenna transceiver system having a plurality of beamforming sub-systems connected to respective transceiver chains. For example, a (e.g., each) beamforming sub-system may be connected to a single transceiver chain, or to two or more transceiver chains.

When a beamforming sub-system is connected to a number of transceiver chains, wherein the number of transceiver chains is more than one and less than a number of antenna elements of the beamforming sub-system, the beamforming sub-system is a hybrid beamforming sub-system.

When a beamforming sub-system is connected to a single transceiver chain, the beamforming sub-system is an analog beamforming sub-system.

Each beamforming sub-system is comprised in an access point of a distributed multiple-input multiple-output (MIMO) system, and each beamforming sub-system is associated with a set of available beams. For example, an (e.g., each) access point of the distributed MIMO system may comprise a single beamforming sub-system, or two or more beamforming sub-systems.

For example, the method 100 may be performed by a control device of the distributed MIMO system.

In step 110, pairs of one transmission beam and one reception beam are selected. The beams of a pair are selected from the set of available beams of different ones of the beamforming sub-systems. Thus, each pair comprises a single transmission beam selected from the set of available beams of a first beamforming sub-system and a single reception beam selected from the set of available beams of a second beamforming sub-system, wherein the first and second beamforming sub-systems are different beamforming sub-systems.

In step 120, the beamforming sub-systems are instructed to use each selected pair of one transmission beam and one reception beam for sounding signal measurements in a respective measurement resource. A respective measurement resource may be defined by a frequency resource and/or a time resource. For example, a respective measurement resource may be a resource unit (RU; e.g., a physical resource block, PRB) or similar.

The sounding instruction of the beamforming sub-systems may be accomplished in any suitable way. For example, step 120 may be implemented by transmitting control signaling to the beamforming sub-systems (e.g., a collective control signal for all of the beamforming sub-systems, or respective control signals dedicated to each of the beamforming sub-systems).

Based on the instruction of step 120, the plurality of beamforming sub-systems use the selected pairs of one transmission beam and one reception beam for sounding signal measurements in the respective measurement resources. For a measurement resource, this may be accomplished by transmission of a sounding signal in the measurement resource and performing channel measurements on the sounding signal. The sounding signal is transmitted using the transmission beam of the pair; by the beamforming sub-system from whose set of available beams the transmission beam was selected. The channel measurements are performed using the reception beam of the pair; by the beamforming sub-system from whose set of available beams the reception beam was selected. The sounding signal may be any signal suitable for sounding and the channel measurements may be any measurements suitable for channel estimation.

As illustrated by optional step 130, the method 100 may comprise acquiring measurement reports from the beamforming sub-systems, wherein the measurement reports indicate quality of the sounding signal measurements.

The acquisition of the measurement reports may be accomplished in any suitable way. For example, step 130 may be implemented by receiving the measurement reports from the beamforming sub-systems.

In some embodiments, the measurement reports are acquired after all sounding signal measurements have been completed.

In some embodiments, the measurement reports are acquired during performance of the sounding signal measurements (e.g., each measurement report may relate to one or more measurement resource for which sounding signal measurements have been completed, and may be acquired while sounding signal measurements have not been completed for one or more other measurement resource).

As illustrated by optional step 140, the method 100 may comprise determining whether the sounding signal measurements meet a measurement quality criterion (a second measurement quality criterion in the wording of the claims) for all beamforming sub-systems. The determination may be based on the acquired measurement reports of step 130.

For example, it may be determined that the sounding signal measurements meet the measurement quality criterion when a quality metric exceeds a threshold value. The quality metric may be any suitable metric. Examples include received signal strength, signal-to-noise ratio (SNR), signal-to-interference ratio (SIR), and signal-to-interference-and-noise ratio (SINR); e.g., average values over a number of previous measurements of a particular beam. The threshold value may be any suitable threshold value; e.g., a percentile (such as a 10% percentile) of any of the above average values.

When the sounding signal measurements do not meet the measurement quality criterion for all beamforming sub-systems (N-path out of step 140) and when all pairs selected in step 110 have been used for sounding signal measurements, the method 100 may loop back to step 110 where other pairs of one transmission beam and one reception beam are selected for further sounding signal measurements. This process may continue until all possible pairs have been selected and used for sounding signal measurements.

When the sounding signal measurements do not meet the measurement quality criterion for all beamforming sub-systems (N-path out of step 140) and when all pairs selected in step 110 have not been used for sounding signal measurements, the method 100 may loop back to step 130 where measurement reports are acquired for further sounding signal measurements performed using the pairs selected in step 110.

When the sounding signal measurements meet the measurement quality criterion for all beamforming sub-systems (Y-path out of step 140), the method 100 may continue to optional step 150, where the sounding signal measurements are discontinued.

By selecting less than all possible pairs in the first execution of step 110 and/or by application of the discontinuation, the amount of signaling overhead due to over-the-air calibration signaling can be reduced while proper sounding result is still achievable.

As illustrated by optional step 160, respective beamforming calibration factors may be determined for the transceiver chains based on the sounding signal measurements. The determination may be based on the acquired measurement reports of step 130.

Typically, the determination in step 160 is performed when the sounding signal measurements have been completed, or discontinued. It should be noted that steps 140 and 150 may be omitted in some embodiments, and the method 100 may proceed directly from step 130 to step 160.

Each beamforming calibration factor cᵢ may represent a ratio between receiver path gain rᵢ^{AP} and transmitter path gain tᵢ^{AP} for a corresponding transceiver chain i, i.e., cᵢ=rᵢ^{AP}/tᵢ^{AP}. For example, rᵢ^{AP} may denote a narrowband frequency response of the receiver chain of AP i and tᵢ^{AP} may denote a narrowband frequency response of the transmitter chain of AP i.

Alternatively, each beamforming calibration factor c may represent a ratio between transmitter path gain tᵢ^{AP} and receiver path gain rᵢ^{AP} for a corresponding transceiver chain i, i.e., cᵢ=tᵢ^{AP}/rᵢ^{AP}.

In some embodiments, determining respective beamforming calibration factors comprises performing joint iterative minimization, wherein each iteration n comprises updating estimates for the beamforming calibration factors ĉᵢⱼ⁽ⁿ⁺¹⁾ based on a calibration nuisance estimate of a previous iteration (e.g., expressed via a calibration nuisance matrix Ê_{i,j}⁽ⁿ⁾), and updating the calibration nuisance estimate E based on the updated estimates for the beamforming calibration factors ĉ_{i,j}⁽ⁿ⁺¹⁾, where i,j indexes a pair of beamforming sub-systems.

As illustrated by optional step 170, one or more of the beamforming sub-systems may be instructed to transmit a beamformed communication signal based on reverse channel estimation and the determined beamforming calibration factors.

The communication instruction of the beamforming sub-systems may be accomplished in any suitable way. For example, step 170 may be implemented by transmitting control signaling to the beamforming sub-systems (e.g., a collective control signal for all of the one or more beamforming sub-systems, or respective control signals dedicated to each of the one or more beamforming sub-systems).

Based on the instruction of step 170, the one or more beamforming sub-systems use the reverse (i.e., UL in this scenario) channel estimates and the determined beamforming calibration factors for beamformed communication signal transmission.

There are several approaches for implementing the selection of step 110.

In one approach, selecting pairs of one transmission beam and one reception beam comprises selecting all possible pairs for the plurality of beamforming sub-systems, as illustrated by optional sub-step 111. If the sounding measurements for such a selection is carried out without discontinuation, it corresponds to a full sweep. A selection of all possible pairs for the plurality of beamforming sub-systems may be performed in a single execution of step 110, or may be performed successively during several executions of step 110 (e.g., due to loop back from step 140).

In one approach, selecting pairs of one transmission beam and one reception beam comprises selecting less than all possible pairs for the plurality of beamforming sub-systems, as illustrated by optional sub-step 112. Thus, only some pairs are used in the sounding signal measurements. A selection of less than all possible pairs for the plurality of beamforming sub-systems may be performed in a single execution of step 110, or may be performed successively during several executions of step 110 (e.g., due to loop back from step 140).

For example, the selected pairs may comprise at least one transmission beam per beamforming sub-system (i.e., all beamforming sub-systems transmits sounding signals using at least one transmission beam during the sounding signal measurements). Alternatively or additionally, the selected pairs may comprise at least one reception beam per beamforming sub-system for each selected transmission beam (i.e., for each sounding signal transmission during the sounding signal measurements, all beamforming sub-systems performs measurements using at least one reception beam).

In some embodiments, sub-step 112 may comprise selecting beam pairs based on previous selections and/or previous measurement results, as illustrated by optional sub-sub-step 113. For example, sub-step 112 may comprise selecting beam pairs (or beams that belong to a beam pair) that have previously provided sounding signal measurements that meet a measurement quality criterion (a first measurement quality criterion in the wording of the claims).

For example, meeting the measurement quality criterion may comprise having a quality metric that exceeds a threshold value, or having the best quality metric among beams of the beamforming sub-system. The quality metric may be any suitable metric. Examples include received signal strength, signal-to-noise ratio (SNR), signal-to-interference ratio (SIR), and signal-to-interference-and-noise ratio (SINR); e.g., average values over a number of previous measurements of a particular beam. The threshold value may be any suitable threshold value; e.g., a percentile of any of the above average values. The first threshold value may be the same as, or different from, the second threshold value referred to above.

In some implementations of sub-sub-step 113, all transmission beams of a beamforming sub-system are selected, but only one reception beam is selected for each transmission beam per beamforming sub-system (e.g., the one that previously has provided the best quality metric among the reception beams for that transmission beam).

In some implementations of sub-sub-step 113, only one transmission beam of a beamforming sub-system are selected, and only one reception beam is selected for each transmission beam per beamforming sub-system (e.g., the pair that previously has provided the best quality metric for that beamforming sub-system combination).

A selection based on previous measurement results (as illustrated by sub-sub-step 113) may be performed in a first execution of step 110. In subsequent executions of step 110 (e.g., due to loop back from step 140), the selection may be extended to other pairs. For example, the selection may be extended to pairs that comprise transmission and/or reception beams adjacent to those selected in the first execution of step 110, or to all pairs other than those selected in the first execution of step 110.

Step 110 may comprise selecting a first set of pairs and selecting at least a second set of pairs (either in a single execution of step 110 or in subsequent executions of step 110; e.g., due to loop back from step 140), and step 120 may comprise instructing the beamforming sub-systems to use each selected pair of the first set for sounding signal measurements in a collection of first respective measurement resources and instructing the beamforming sub-systems to use each selected pair of the second set for sounding signal measurements in a collection of second respective measurement resources (either in a single execution of step 120 or in subsequent executions of step 120; e.g., due to loop back from step 140), wherein the collection of second respective measurement resources occurs later in time than the collection of first respective measurement resources.

In some embodiments, a hierarchical approach is used for the beam width (i.e., beams of the first set of pairs are wider than beams of the second set of pairs).

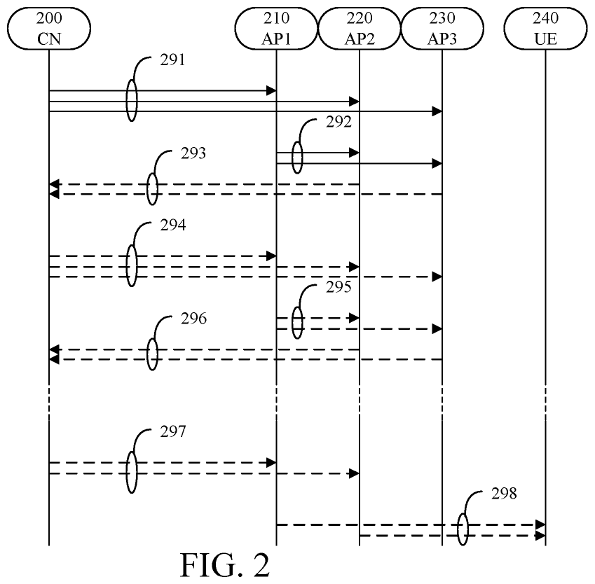

FIG. 2 illustrates example signaling according to some embodiments, between a control node (CN; e.g., a control device of a distributed MIMO system) 200 and a plurality of access points (AP1, AP2, AP3; e.g., access points of a distributed MIMO system) 210, 220, 230, wherein each access point comprises a beamforming sub-system. The control node 200 may, for example, be configured to perform the method 100 of FIG. 1.

The control node 200 transmits control signaling 291 to the access points 210, 220, 230 (compare with 120 of FIG. 1) to instruct the beamforming sub-systems to use pairs of one transmission beam and one reception beam for sounding signal measurements in a respective measurement resource, wherein the pairs have been selected by the control node 200 (compare with 110 of FIG. 1).

Based on the instruction conveyed by the control signaling 291, the beamforming sub-systems of the access points 210, 220, 230 use the selected pairs of one transmission beam and one reception beam for sounding signal measurements in the respective measurement resources. This is represented in FIG. 2 by transmission of a sounding signal 292 from the access point 210, which is used by the access points 220, 230 to perform measurements. Of course, there are typically (many) more sounding signal transmissions than represented in FIG. 2.

The access points 220, 230 that have performed measurements may transmit measurement reports 293, which are received by the control node 200 (compare with step 130 of FIG. 1).

When the sounding signal measurements do not meet a measurement quality criterion for all beamforming sub-systems, the sounding process may be continued. This is illustrated in FIG. 2 by the control node 200 transmitting further control signaling 294 to the access points 210, 220, 230 (compare with 291 and with 120 of FIG. 1).

Based on the instruction conveyed by the further control signaling 294, the beamforming sub-systems of the access points 210, 220, 230 performs further sounding signal measurements. This is represented in FIG. 2 by transmission of a further sounding signal 295 from the access point 210, which is used by the access points 220, 230 to perform further measurements. Of course, there are typically (many) more further sounding signal transmissions than represented in FIG. 2.

The access points 220, 230 that have performed further measurements may transmit measurement reports 296, which are received by the control node 200 (compare with step 130 of FIG. 1).

When the sounding signal measurements meet a measurement quality criterion for all beamforming sub-systems, possibly after one or more iterations, the sounding process may be considered completed (compare with 150 of FIG. 1).

After determining respective beamforming calibration factors (compare with 160 of FIG. 1), the control node 200 may transmit control signaling 297 to the access points 210, 220, 230 (compare with 170 of FIG. 1) to instruct the beamforming sub-systems to transmit a beamformed communication signal based on reverse channel estimation and the determined beamforming calibration factors.

Based on the instruction conveyed by the control signaling 297, the beamforming sub-systems of the access points 210, 220, 230 use the reverse channel estimates and the determined beamforming calibration factors for beamformed communication signal transmission. This is represented in FIG. 2 by transmission of a communication signal 298 from the access points 210, 220, which is received by a user equipment (UE) 240. Of course, there may typically be more communication signal transmissions than represented in FIG. 2.

As mentioned above, some embodiments are particularly beneficial for calibration of a distributed MIMO system (D-MIMO; e.g., cell-free MIMO, also known as large scale distributed MIMO) that apply beamforming in the access points. For example, embodiments may be used to calibrate access points of a distributed MIMO system for coordinated transmission.

Distributed MIMO systems include, for example, systems embodied using radio stripes, and systems compliant with Third Generation Partnership Project (3GPP) standards (relating to, e.g., fifth generation new radio, 5G NR, or sixth generation implementations).

Deployments of distributed MIMO may, for example, be used to provide good coverage and high capacity for areas with high requirements (e.g., in terms of data rate, throughput, latency, etc.). Some examples of such areas include factory buildings, stadiums, office spaces, airports, etc.

One challenge of MIMO systems using a large amount of antenna elements is that obtaining explicit channel estimation becomes cumbersome due to that the signaling overhead (e.g., training signaling using reference signals) required for channel estimation typically scales linearly with the number of antennas (and/or with the size of the beamforming codebook). Furthermore, extensive feedback (e.g., in form of channel state information, CSI) may also be required.

An alternative to using explicit channel estimation (e.g., supported in 3GPP NR release 15), is to rely on channel reciprocity and use reverse link training signaling to estimate forward link channels and select corresponding forward link beamforming. It should be noted that such an approach may be applied when the forward link is a downlink (DL) and the reverse link is an uplink (UL), as well as when the forward link is an uplink and the reverse link is a downlink.

For solutions with fully digital beamforming (i.e., one transceiver chain per antenna element), only one training signal—and consequently only one radio resource—is typically needed per forward link stream when applying the channel reciprocity approach. Thus, the signaling overhead typically scales linearly with the number of forward link streams (which is usually much smaller than the number of antennas and the size of the beamforming codebook).

The channel reciprocity approach may be useful, for example, in a multi-user (MU) MIMO context when a fully digital base station (BS) with many antenna elements uses UL channel estimates to select beamforming for DL data streams to user equipments (UEs), and/or when a distributed BS (comprising a plurality of distributed access points, APs, each equipped with one or more antenna element(s)) uses UL channel estimates to jointly select pre-coding for DL data streams to UEs.

However, even in situations when the propagation channel can be considered to be reciprocal, the analog front-end circuitry of both UE and BS/AP typically makes the baseband-to-baseband channel non-reciprocal. One solution to this problem is to calibrate transceiver chains in the transmitting device to compensate for the impact of analog front-end circuitry, thereby rendering the baseband-to-baseband channel reciprocal (or at least closer to reciprocal than in the un-calibrated case).

Thus, in order to facilitate joint and coherent transmissions from APs to UEs in a distributed MIMO system, the system needs to be properly calibrated. Typically, the channel estimation used for the joint coherent transmissions is derived from uplink channel soundings, and reciprocity is assumed for the propagation channel.

There exist different types of calibration approaches in the literature that restore some degree of reciprocity of a wireless link.

One approach for calibration to improve the baseband-to-baseband channel reciprocity is to perform bi-directional over-the-air (OTA) signaling and measurements between the UEs and the APs, and collectively estimate proper calibration coefficients for the UEs and APs.

Another approach for calibration to improve the baseband-to-baseband channel reciprocity is to conduct the calibration procedure entirely at the device which is to be calibrated (i.e., one-sided calibration). This approach can be implemented by an internal calibration network in some scenarios. However, using an internal calibration network is typically not practical in distributed MIMO systems. This approach can also be implemented by (non-bi-directional) over-the-air signaling between some/all pairs of antenna elements, and post-processing of the received signals to estimate calibration coefficients.

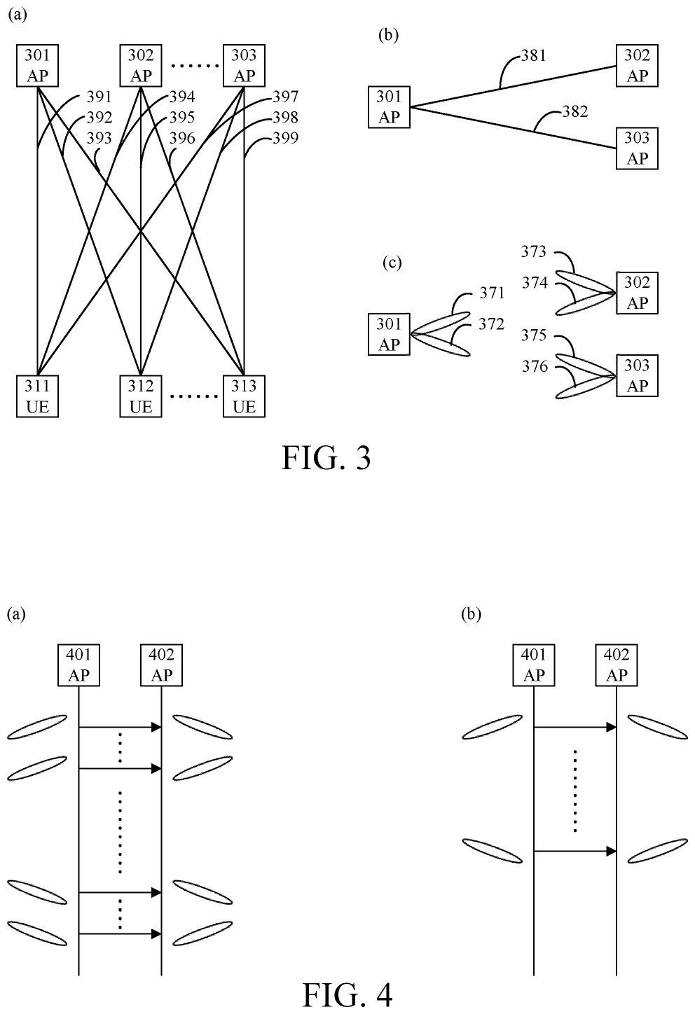

This disclosure focuses on calibration to improve the baseband-to-baseband channel reciprocity, where the calibration procedure is conducted entirely at the device which is to be calibrated (the distributed MIMO system, comprising a plurality of access points and a control device) using (non-bi-directional) over-the-air signaling is between pairs of APs and post-processing of the received signals to estimate calibration coefficients. A mathematical exemplification of this type of calibration will now be provided with reference to FIG. 3, which schematically illustrates some example channels and beamforming principles.

For illustrative but non-limiting purposes, a narrowband MIMO link is assumed with M antenna ports at one end (side A; e.g., AP/BS side) and K antenna ports at the other end (side B; e.g., UE side).

Side A can be the AP side of a cell-free massive MIMO link. For the purpose of illustration, it will be assumed that each AP is single-antenna (e.g., single polarization), has one transceiver chain, and is geographically distributed. It should be noted, however, that approaches presented herein may be equally applicable for when one or more of the APs has more than one transceiver chain. Side B can be made up by K single-antenna UEs, a K-antenna UE, or a mix of single antenna and plural antenna UEs. For the purpose of illustration, it will be assumed that each UE is single-antenna. In massive MIMO, it can typically be assumed that M»K.

An example of such a system is depicted in part (a) of FIG. 3, where M distributed APs 301, 302, 303 each have a corresponding propagation channel 391, 392, 393; 394, 395, 396; 397, 398, 399 to/from each of K UEs 311, 312, 313. Each AP m=1, . . . , M has a corresponding transmitter path gain tₘ^{AP} and receiver path gain rₘ^{AP}, and each UE k=1, . . . , K has a corresponding transmitter path gain tₖ^{UE} and receiver path gain rₖ^{UE}. The reciprocal propagation channel between AP m=1, . . . , M and UE k=1 , . . . , K is denoted h_{m, k}. The baseband-to-baseband uplink channel can be expressed H_{UL}=R_{AP}HT_{UE}, and the baseband-to-baseband downlink channel can be expressed H_{DL}=R_{UE}H^{T}T_{AP}, where H represents the propagation channel, T_{UE}=diag{t₁^{UE} , . . . , t_{K}^{UE}}, R_{UE}=diag{r₁^{UE} , . . . , r_{K}^{UE}} R_{AP}=diag{r₁^{AP} , . . . , r_{M}^{AP}}, and T_{AP}=diag{t₁^{AP} , . . . , t_{M}^{AP}}. For example, H_{UL} may be seen as an M×K uplink narrowband radio channel representing an orthogonal frequency division multiplex (OFDM) subcarrier, physical resource block (PRB), or a PRB group.

Even if the propagation channel H is assumed to be reciprocal in a time/frequency coherence interval, the end-to-end radio channels H_{UL} and H_{DL} (or the baseband-to-baseband channels) are generally not reciprocal because the gain/response of the transceiver circuitry is not reciprocal (e.g., T_{AP} is generally different than T_{UE}). Therefore, it is not straightforward to base downlink transmission on channel estimates obtained from uplink sounding signals. Therefore, it may be desirable to find a channel calibration that makes the effective, baseband-to-baseband, channel in a forward direction (e.g., DL) closer to reciprocal to the effective, baseband-to-baseband, channel of an opposite direction (e.g., UL) than the un-calibrated channel in the forward direction (e.g., H_{DL}) is.

Assuming that the AP side of the link has knowledge of the calibration matrix

$$C = diag \{ {c}_{1} , … , {c}_{M} \} = {α ( {T}_{AP} )}^{- 1} {R}_{AP} = α diag \{ \frac{{r}_{1}^{AP}}{{t}_{1}^{AP}} , … , \frac{{r}_{M}^{AP}}{{t}_{M}^{AP}} \} ,$$

where α denotes a non-zero complex-valued (possibly unknown) scaling term, the problem with non-reciprocal baseband-to-baseband channels may be addressed as follows.

The AP side can estimate H_{UL} via UL reference signaling. If the AP side aims to jointly perform zero-forcing (ZF) transmission to the UE(s) based on that estimation, this may be accomplished by the taking the Moore-Penrose inverse of H_{UL}^{T}; i.e., W=H*_{UL}(H_{UL}^{T}H*_{UL})⁻¹, where ( )* denotes element-wise complex conjugation. However, since W is constructed based on UL reference signals, it is not matched to the non-reciprocal DL channel H_{DL}. This may be solved by each AP multiplying the pre-coded signal with its associated entry of C (i.e., the pre-coded signal at transceiver m is multiplied with cₘ, and each AP only needs to know its specific entry of C and not the entire C matrix). Then, the effective DL channel (which includes calibration C, pre-coding W, and DL propagation channel H_{DL}) may be expressed as

$$\begin{matrix}{H}_{{DL}_{eff}} = {H}_{DL} C W \\ = {H}_{DL} C {{H}_{UL}^{*} ( {H}_{UL}^{T} {H}_{UL}^{*} )}^{- 1} \\ = {H}_{DL} C {R}_{AP}^{*} {H}^{*} {{T}_{UE}^{*} ( {T}_{UE} {H}^{T} {\vert {R}_{AP} \vert}^{2} {H}^{*} {T}_{UE}^{*} )}^{- 1} \\ = {H}_{DL} {α ( {T}_{AP} )}^{- 1} {\vert {R}_{AP} \vert}^{2} {H}^{*} {{T}_{UE}^{*} ( {T}_{UE} {H}^{T} {\vert {R}_{AP} \vert}^{2} {H}^{*} {T}_{UE}^{*} )}^{- 1} \\ = {H}_{DL} {α ( {T}_{AP} )}^{- 1} {H}^{- T} {( {T}_{UE} )}^{- 1} \\ = α {R}_{UE} {H}^{T} {T}_{AP} {( {T}_{AP} )}^{- 1} {H}^{- T} {( {T}_{UE} )}^{- 1} \\ = α {R}_{UE} {( {T}_{UE} )}^{- 1} ,\end{matrix}$$

which is a diagonal channel matrix with unknown diagonal entries. As a result, the ZF DL transmission is successful since there is no inter-stream interference. It should be noted that ZF pre-coding is merely an example, and that embodiments may be equally applicable for any suitable pre-coder (e.g., maximum ratio transmission, MRT).

Each unknown diagonal entry of the effective DL channel is made up of the calibrated beamformer and propagation channel from all APs and to the UE corresponding to that entry. Thus, the unknown diagonal entries can be estimated using only one DL reference signal, beamformed in the DL towards all UEs, and using the calibration. Thus, K UL reference signals plus one DL reference signal are enough to conduct all training needed for this (calibrated) reciprocity-based transmission approach. This results in much less signaling overhead due to training than for explicit DL channel estimation of all pairs of antennas, which would consume about M radio resources for signaling and additional radio resources for feedback from the UEs.

In conclusion, knowledge of the calibration matrix C enables coherent transmissions (e.g., ZF DL transmissions) with no (or very little) inter-user interference over a calibrated effective channel, and some embodiments aim for estimation of its diagonal elements (calibration coefficients).

When considering fully-digital, typically co-located, massive MIMO systems, the estimation of the calibration coefficients, one per BS transceiver (each BS transceiver corresponding to one AP in part (a) of FIG. 3), may be performed as follows. The M AP transceivers are sounded one-by-one by, for each of M radio resources, transmitting a sounding signal from one AP transceiver and receiving the sounding signal on the other M−1 (silent) AP transceivers. The received signals for all pairs of AP transceivers can be compactly written in matrix form as Y=R_{AP}H_{c}T_{AP}+N, where the symmetric matrix H_{c} represents the propagation channels between all pairs of AP transceiver chains, and the entries of N represents modelled noise contributions during the measurements. The diagonal entries of H_{c} (and consequently those of Y) are undefined for most practical cases, since an AP transceiver typically cannot transmit and receive in a same radio resource. It should be noted however, that the principles elaborated in herein can be generalized to the case where an AP transceiver can transmit and receive in a same radio resource.

Part (b) of FIG. 3 illustrates this principle, where an AP transceiver i, i=1, . . . , M 301 transmits a sounding signal which is received on the other AP transceivers j, j≠i, j=1, . . . , M 302, 303. The corresponding channels h_{i,j}^{c} 381, 382 represent elements in the i^{th} column of H_{c} (the diagonal elements h_{m,m}^{c} are undefined and may be set to zero, and h_{i,j}^{c}=h_{j,i}^{c} due to reciprocity of the propagation channel);

$${H}_{c} = [ \begin{matrix}0 & {h}_{1 , 2}^{c} & ⋯ & {h}_{1 , M}^{c} \\ {h}_{2 , 1}^{c} & 0 & ⋯ & {h}_{2 , M}^{c} \\ ⋮ & ⋮ & ⋱ & ⋮ \\ {h}_{M , 1}^{c} & {h}_{M , 2}^{c} & ⋯ & 0\end{matrix} ] = [ \begin{matrix}0 & {h}_{1 , 2}^{c} & ⋯ & {h}_{1 , M}^{c} \\ {h}_{2 , 1}^{c} & 0 & ⋯ & {h}_{2 , M}^{c} \\ ⋮ & ⋮ & ⋱ & ⋮ \\ {h}_{M , 1}^{c} & {h}_{M , 2}^{c} & ⋯ & 0\end{matrix} ] .$$

The measurement matrix (i.e., the received signals) can be expressed as

$$Y = {R}_{AP} {H}_{c} {T}_{AP} + N = {R}_{AP} {H}_{c} {R}_{AP} {R}_{AP}^{- 1} {T}_{AP} + N = \frac{1}{α} {R}_{AP} {H}_{c} {R}_{AP} C + N = PC + N ,$$

showing the relationship between the sought calibration matrix C and the measurement matrix Y.

It may be noted that P is a symmetric matrix with generally undefined diagonal elements. Thus, the number of parameters in P is (M²−M)/2. The number of parameters in the diagonal matrix C is M. Thus, since the measurement matrix Y has M²−M observations, and

$${M}^{2} - M \geq \frac{{M}^{2} - M}{2} + M ,$$

for M≥3, the above mentioned measurement procedure provides a measurement set that is sufficient to estimate the calibration matrix C.

There are existing approaches for estimating the calibration coefficients based on the observation matrix Y. However, the existing approaches for estimation of the calibration coefficients are designed for fully-digital beamforming (i.e., one transceiver chain per antenna element), and are typically only suitable for co-located transceivers (e.g., MIMO base stations).

Hence, there is a need for approaches for estimation of the calibration coefficients which are suitable for distributed MIMO systems (e.g., where some, or all, APs have some not fully-digital beamforming capabilities). Examples of such not fully-digital beamforming capabilities include analog beamforming capabilities where an AP has a single transceiver chain but more than one antenna element, and hybrid beamforming capabilities where an AP has a less transceiver chain than antenna elements. Thus, an example distributed network may have APs with a large effective aperture and/or a large number of antenna elements, but only one, two, or a few antenna port(s).

Part (c) of FIG. 3 illustrates a sounding scenario for such distributed MIMO systems, where each AP 301, 302, 303 has L antenna elements and corresponding L possible beams 371, 372; 373, 374; 375, 376. A problem encountered in this type of scenario is that the transmission of a sounding signal from an AP transceiver i, i=1, . . . , M 301 and the corresponding reception at the other AP transceivers j, j≠i, j=1, . . . , M 302, 303 needs to be performed using beamforming since it is generally not possible to by-pass the beamforming of the transmit and receive antenna arrays when the calibration is performed.

Some embodiments presented herein relate to approaches suitable for these types of situations. Approaches are presented for over-the-air sounding and measurements between APs with multiple antenna elements. The transmitting AP may perform a full or partial beam sweep of its transmit beams at different time instances, in which the other APs act as receivers and perform a full or partial beam sweep of their respective receive beams. Some embodiments present approaches for reduction of the signaling overhead due to over-the-air calibration, by application of one or more criteria specifying when an ongoing calibration beam sweep may be terminated. For example, termination may be considered when one or more (e.g., all) pairs of APs have found a reliable beam combination for calibration. Furthermore, approaches are presented for processing the measurements to estimate the calibration matrix C.

Compared to existing solutions, some embodiments provide more efficient calibration for distributed MIMO systems. This may be due to one or more of a higher link budget during over-the-air measurements (due to proper alignment of beam pairs between all APs), lower signaling overhead, and more efficient post processing that take into account the beamforming features used during the sounding. Another advantage of some embodiments relate to that it is realized that it is enough to calibrate only for the ratios

$$\frac{{r}_{, m}^{AP}}{{t}_{m}^{AP}} ( i . e . ,$$

it is not necessary to estimate rₘ^{AP} and tₘ^{AP} separately). Another advantage of some embodiments relate to that the scalability is reasonable when the number of antenna elements and/or the number of transceiver chains and/or the number of APs increases, as the number of groups increase. Furthermore, embodiments presented herein do not rely on utilizing UE measurements for the calibration.

For the situation exemplified in part (c) of FIG. 3 (i.e., the context of cell-free MIMO with multi-antenna APs which are capable of beamforming), a signal model which is analogous to Y=R_{AP}H_{c}T_{AP}+N mentioned earlier may be expressed as y(fⱼ, bᵢ)_{j,i}=rⱼ^{AP}fⱼ^{T}H_{c}^{j,i}bᵢtᵢ^{AP}+n_{j,i}=rⱼ^{AP}g_{j,i}(fⱼ, bᵢ)tᵢ^{AP}+n_{j,i} when the i^{th} AP transmits and the j^{th} AP receives, where the symmetric matrix H_{c}^{j,i} denotes the (reciprocal) propagation channel from all antenna elements of AP i to all antenna elements of AP j. Referring to part (b) of FIG. 3, H_{c}^{1,i} of size L×L may be correspond to 381 and H_{c}^{M,i} of size L×L may be correspond to 382. The column vectors bᵢ and fⱼ represent the beamformers used at the transmitter i and receiver j, respectively, and g_{j,i}(fⱼ, bᵢ) is a complex-valued number representing the effective channel gain, parameterized by the transmit and receive beamformers.

A challenge that arises from the context of calibration of cell-free MIMO for multi-antenna APs is that if the (typically analog) beamformers bᵢ and fⱼ are configured erroneously, then the resulting channel g_{j,i}(fⱼ, bᵢ) may be weak and there may not exist enough link budget or signal-to-noise ratio (SNR) to collect reliable information for calibration from the performed measurements.

Alternatively or additionally, a challenge that arises from the context of calibration of cell-free MIMO for multi-antenna APs is that if different measurements are available (each measurement related to a different combination of settings of the beamformers bᵢ and fⱼ), it may be cumbersome to jointly process the measurements to enhance the estimation accuracy of the calibration coefficients.

Therefore, various embodiments present solutions for a calibration measurement procedure between beamforming APs, for reducing the complexity of the calibration measurement procedure, and for processing the measurements to estimate the calibration coefficients.

Calibration Measurement Procedure (Exemplification of 110 and 120 of FIG. 1)

The above-defined model for y(fⱼ, bᵢ)_{j,i} shows that the beamforming impacts the quality of the measurements via the equivalent channel gain g_{j,i}. Hence, one goal of the measurement procedure may be to find one or more suitable beam pair per AP pair (transmitter-receiver) that enables reliable measurements for calibration.

FIG. 4 illustrates some example sounding approaches according to some embodiments. The part of the example sounding approaches is shown for transmission from an AP 401 and reception by another AP 402.

For illustrative and non-limiting purposes, it will be assumed that the distributed MIMO system has M one-antenna port APs, and that each AP is capable of L (transmit and receive) beams.

A possible measurement procedure is as follows (see also part (a) of FIG. 4).
1. Define the set S={1,2, . . . , M}.
2. In a collection of radio resources, the m^{th} AP 401 sounds each of its L transmit beams, wherein each transmit beam is sounded L times (i.e. the AP transmits L sounding signals in each of the L beams. Thus, the total signaling overhead per AP due to sounding is L². See left portion of part (a) of FIG. 4.
3. Each of the other APs 402 receive the L² sounding signals using each of the receive beams (i.e., the receive codebook is fully used for each of the transmit beams sounded by the m^{th} AP 401). See right portion of part (a) of FIG. 4.
4. Remove m from the set S; i.e., S={1,2, . . . , m−1, m+1, . . . , M}, and if S≠{ }, repeat steps 2 and 3 with another value of m drawn from S.

Thus, referring to part (a) of FIG. 4, AP i 401 sounds a first transmission beam b₁ L times, then sounds a second transmission beam b₂ L times, and so on until an L^{th} transmission beam b_{L} has been sounded L times. During the L-fold sounding of each transmission beam, each of the other APs j, j #i applies all its L receive beams f₁, . . . , f_{L}, one after another. This is repeated for i=1, . . . , M, and the total signaling overhead due to sounding is ML².

The signal model y(fⱼ, bᵢ)_{j,i}=rⱼ^{AP}fⱼ^{T}H_{c}^{j,i}bᵢtᵢ^{AP}+n_{j,i} for the full beam sweep can also be written as Y_{j,i}=rⱼFⱼ^{T}H_{c}^{j,i}Bᵢtᵢ+N_{j,i}, where Bᵢ=[bᵢ(1) . . . bᵢ(L)] denotes the transmit codebook matrix which contains all the L possible settings of the transmit beamformer, and Fⱼ=[fⱼ(1) . . . fⱼ(L)] denotes the receive codebook matrix which contains all L possible settings of the receive beamformer. The matrix Y_{j,i} contains the measurements resulting from all beamformer pair combinations between the transmitter i and the receiver j, and N_{j,i} represents the corresponding measurement noise.

This approach represents a full transmit and receive beam sweep, and provides an extensive measurement set for calibration, since all possible beam pair combinations are sounded. It may be used as a bootstrap procedure to identify which transmit and receive beams are most relevant for calibration.

System calibration typically needs to be repeated (e.g., periodically and/or event based) since changes (e.g., component temperature, clock drift, local oscillator drift, etc.) might eventually cause the calibration to degrade. For one or more of the calibrations the number of sounding transmissions may be significantly reduced.

Thus, in some embodiments, the full sweep process may be performed seldom—for example, once (initially) and/or is repeatedly (e.g., at periodical intervals and/or based on a triggering event, such as detection of poor calibration quality)—and another process with less signaling overhead may be performed more often. For example, the process with less signaling overhead may be based on the transmit and receive beams that are identified as most relevant for calibration during the bootstrap procedure.

As already mentioned, the total signaling overhead due to sounding is ML² for a full beam sweep. For proper calibration of the entire distributed MIMO system, the factor M can generally not be reduced. Thus, to reduce the complexity (i.e., the signaling overhead due to sounding) of the measurement procedure, the factor L² is considered.

Reducing the Complexity of the Calibration Measurement Procedure (Exemplification of 110, 120, 130, 140 and 150 of FIG. 1)

The signaling overhead factor L² arises when a full beam sweep is conducted (i.e., when all beam pairs are sounded) between APs with L transmit beams and L receive beams.

To reduce the signaling overhead, the beam sweeping between a pair of APs may be stopped when a beam pair is found that yield a sufficiently reliable link for calibration (e.g., when received signal strength and/or received SNR exceeds a threshold value). For example, N<L² beam pairs may be sounded sequentially and feedback may be acquired when the sounding of the N beam pairs is complete. In the feedback, an AP in receive mode may report whether or not a sufficiently reliable link can be obtained using one or more of the N sounded beam pairs. If so, the sounding procedure may be stopped. Otherwise, the sounding procedure may continue by sounding more beam pairs.

Alternatively or additionally, beam tracking may be employed to reduce the signaling overhead. That is, when a beam pair has performed well in a recent past, it may be considered likely that that beam pair might also perform well at a current time. Thus, beam pairs that have previously yielded a sufficiently reliable link for calibration may be used for updated sounding (possibly together with one or more of their neighboring beams).

The beam tracking approach may be used in isolation or may be combined with the feedback approach (i.e., first sounding beam pairs that have previously performed well, stopping the sounding when acquired feedback indicates that a sufficiently reliable link can be obtained using the sounded beam pairs, and continuing sounding other beam pairs otherwise.

In an example approach for reduced signaling overhead, the transmit beams are fully swept while only one or a few (e.g., the previously best) receive beam(s) is/are used per transmit beam. One example is illustrated in part (b) of FIG. 4, where only one (e.g., the previously best) receive beam is used by AP 402 for each transmit beam sounded by AP 401. Thus, AP i 401 sounds a first transmission beam b₁ once, then sounds a second transmission beam b₂ once, and so on until an L^{th} transmission beam b_{L} has been sounded once. During the sounding of each transmission beam, each of the other APs j, j≠i applies one (e.g., the previously best) of its L receive beams. This is repeated for i=1, . . . , M, and the total signaling overhead due to sounding is ML.

Alternatively or additionally, the transmit and receive beam pairs may be pruned for reduced signaling overhead, as will be exemplified in the following.

In a first step, it may be determined which beam pairs give useful measurements for calibration. For example, an initial full sweep of transmit and receive beams may be performed, and the measurements may be sorted into useful and non-useful by comparison to a threshold value (e.g., useful when received signal strength and/or received SNR exceeds a threshold value). The comparison may be performed at the APs and feedback to the controller may be an L×L matrix I_{i,j} in which a first entry value (e.g., zero) indicates a non-useful beam pair and a second entry value (e.g., one) indicates a useful beam pair. Alternatively, feedback to the controller may comprise the measurement values (or a quantified version thereof) and the comparison may be performed at the controller.

In a second step, a set of measurements (i.e., a set of beam pairs) may be determined which is required (or sufficient) for calibration based on the result from the first step.

In a third step, sounding is performed using only the required beam pairs (as determined in the second step).

There are many ways to perform the second step, and one example is presented which uses a simple greedy algorithm. The pseudo-code presented below starts by looping over all transmit APs (i), all transmit beamformers (tx_beam_index), and all receive APs (j). Then, for a given combination of i, tx_beam_index, and j the pseudo-code aims to find one suitable receive beam (rx_beam_index). If a suitable receive beam is found, the algorithm records the information that the AP pair i and j can be sounded by setting the corresponding value on row i and column j to one in the variable measurement_matrix. The receive AP j is then prepared to use the receive beam with index rx_beam_index when transmit AP i transmits a sounding signal using the transmit beam with index tx_beam_index.

Pseudo-code:

%M = number of APs
%L = number of possible transmit (TX) or receive (RX) beamformers in
each AP
%I_{i,j}: Matrix indicating suitable pairs of tx_beam_index and
rx_beam_index
for TX AP i and RX AP j

| | |
|---|---|
| measure_matrix=zeros(M,M) | %matrix to keep track of performed |
| | measurements |
| for i=1:M | %loop over all TX APs |
| for tx_beam_index=1:L | %loop over all TX beamformers in |
| | AP i |
| sound_this_tx_beam=false | %initialization |
| for j=1:M | %loop over all RX APs |

```
      Examine I_{i,j} and determine one acceptable rx_beam_index for
      tx_beam_index
      if (rx_beam_index==null)
```

| | |
|---|---|
| break | %no RX beam found for AP i using |
| | tx_beam_index |

```
      else
        if (measure_matrix(i,j)==0)
          sound_this_beam=true
          prepare sounding using rx_beam_index and tx_beam_index
```

| | |
|---|---|
| measure_matrix(i,j)=1 | %remember that sounding fulfilled |
| | from AP i to AP j |

```
        end
      end
```

| | |
|---|---|
| end | %next RX AP j |

```
    if (sound_this_tx_beam)
      perform sounding of tx_beam_index
    end
```

| | |
|---|---|
| end | % next tx_beam_index |
| end | %next TX AP i |

Of course, this example algorithm can be varied (and possibly improved) in many ways. For example, a more advanced search can be performed resulting in that even fewer sounding measurements need to be performed. Alternatively or additionally, this example algorithm may be modified to the case where actual measurement values are available (not only a binary value indicating if a measurement is useful or not). In some embodiments the example algorithm example is modified to ensure that the same beam pair is used when sounding in forward and reverse directions between two APs.

The pseudo-code presented above describes an implementation where beam identification is done on the fly when sounding is performed (e.g., a transmission beam is sounded as soon as it is determined that it has an acceptable reception beam counterpart). It should be noted that this is not considered as limiting. Contrariety, according to other embodiments, beam identification is done on beforehand and used later when sounding is performed.

In some embodiments, the signaling overhead may be reduced by using hierarchical sounding, as will be exemplified in the following. As before, an objective may be to reduce the signaling overhead by selecting the transmit and receive beamforming vectors in order to maximize (or at least find an acceptable) channel gain g(fⱼ, bᵢ). One efficient way to address this objective is to sound the overall area with one or more wide beam(s) and iteratively narrow down the beam width (and thereby the search space) until arriving at narrow (high resolution) beamforming vectors that provide the best (or at least acceptable) gain; i.e., beams that are properly aligned with the propagation channel H_{c}.

One way to efficiently achieve adequate hierarchical sounding is by using a multiple signal classification (MUSIC) algorithm, a quantized matching pursuit algorithm, or any suitable search technique. The following exemplification of overhead reduction is based on the MUSIC algorithm.

For simplicity, it is assumed that the number L of vectors in the transmit and receive codebook matrices Bᵢ and Fⱼ is a power of two. One approach to reduce the overhead is by choosing P columns of the codebook matrices per iteration (L is a power of P and P«L)), where the choice corresponds to P beams with narrower width for each iteration, estimate the beamforming vector pair that provides the best gain for each iteration, and successively improve the resolution by narrowing the beam width for each iteration.

The process may start with P wide sounding beams (P«L) in iteration 1. Typically, fⱼ, bᵢ i,j∈{1, . . . , P} can be seen as column vectors of a DFT matrix and the overall set of beams may be seen as corresponding to a codebook. The beam pair is chosen which provides the strongest gain g_{j,i}(fⱼ¹,bᵢ¹)based on P² sounding transmissions at iteration 1, e.g., {j₁, i₁}=argmax∥rᵢ^{AP}g_{j,i}(fⱼ¹,bᵢ¹) tᵢ^{AP}∥², where the operator ∥·∥² denotes the squared Frobenious norm of a matrix. The indices {j₁, i₁} correspond to the beam pair with the strongest gain at resolution P.

In iteration 2, P vectors are chosen again from the codebook matrices F and B. Now, the P vectors are chosen in the vicinity of (e.g., centered around) the indices {j₁, i₁} and correspond to less wide sounding beams (e.g., that scan 1/P of the overall area scanned in iteration 1). The beam pair with indices {j₂, i₂} are chosen which provides the strongest gain g_{j,i}(fⱼ²,bᵢ²) based on after P² sounding transmissions at iteration 2. After iteration 2, a total signaling overhead amounts to 2P².

The process may be repeated with more iterations (e.g., Q times) where the beam width (and thereby the search space) is narrowed with each iteration. For each iteration, the additional overhead is P², and after Q iterations the signaling overhead is O(QP²) per access point and O(MQP²) for M APs. Typically, the exhaustive search codebooks may be replaced by using the iterative approach as long as P^{Q}≥L.

In practice, instead of finding the beam indices based on the channel gain, the search may be performed based on the propagation channel H_{c}.

Generally, it may be beneficial if the propagation channel stays approximately constant during sounding between two APs. Reducing the number of sounding measurements, reduces the time required for channel sounding which increases the likelihood that the propagation channel remains approximately constant throughout the whole calibration process.

Also generally, it should be noted that the order in which beams are sounded may be different from the examples provided herein. To reduce the calibration error, the order of sounding of beam pairs can be further improved; e.g. by sounding the forward and reverse directions between two APs as closely in time as possible.

Processing the Measurements to Estimate the Calibration Coefficients (Exemplification of 160 of FIG. 1)

A maximum likelihood (ML) algorithm will now be presented for processing obtained sounding measurements to estimate the calibration coefficients of interest (i.e., the diagonal entries of the matrix C). For simplicity, the calibration will be exemplified by a system with two APs where a full beam sweep has been performed. This is not intended as limiting and adaptation to other approaches described herein is possible.

Based on the distributed MIMO signal model previously described, a vectorized signal model when AP j signals to AP i can be expressed as

$$vec ( {Y}_{i , j} ) = vec ( {r}_{i} {F}_{i}^{T} {H}_{c}^{i , j} {B}_{j} {t}_{j} ) + vec ( {N}_{i , j} ) = vec ( {r}_{i} {r}_{j} {F}_{i}^{T} {H}_{c}^{i , j} {B}_{j} \frac{{t}_{j}}{{r}_{j}} ) + vec ( {N}_{i , j} ) = {r}_{i} {r}_{j} vec ( {F}_{i}^{T} {H}_{c}^{i , j} {B}_{j} ) {c}_{j} + vec ( {N}_{i , j} ) = {r}_{i} {r}_{j} [ \begin{matrix}{F}_{i}^{T} {H}_{c}^{i , j} & 0 \\ 0 & {F}_{i}^{T} {H}_{c}^{i , j}\end{matrix} ] vec ( {B}_{j} ) {c}_{j} + vec ( {N}_{i , j} ) ,$$

where the operator vec(·) stacks the columns of its matrix argument. For simplicity, it is assumed that each AP uses the same beams for transmission and reception (e.g., Bᵢ=Fᵢ and Bⱼ=Fⱼ), and that the propagation matrix is reciprocal (i.e., H_{c}=H_{c}^{i,j}=(H_{c}^{j,i})^{T}).

With that, it follows that the signal model that describes AP i signaling to AP j, and AP j signaling to AP i is

$$[ \begin{matrix}vec ( {Y}_{i , j} ) \\ vec ( {Y}_{j , i}^{T} )\end{matrix} ] = [ \begin{matrix}{r}_{i} {r}_{j} [ \begin{matrix}{F}_{i}^{T} {H}_{c}^{i , j} & 0 \\ 0 & {F}_{i}^{T} {H}_{c}^{i , j}\end{matrix} ] vec ( {B}_{j} ) {c}_{j} \\ {r}_{j} {r}_{i} [ \begin{matrix}{F}_{i}^{T} {H}_{c}^{i , j} & 0 \\ 0 & {F}_{i}^{T} {H}_{c}^{i , j}\end{matrix} ] vec ( {B}_{j} ) {c}_{i}\end{matrix} ] + [ \begin{matrix}vec ( {N}_{i , j} ) \\ vec ( {N}_{j , i}^{T} )\end{matrix} ] = [ \begin{matrix}{E}_{i , j} & 0 \\ 0 & {E}_{i , j}\end{matrix} ] [ \begin{matrix}{c}_{j} \\ {c}_{i}\end{matrix} ] + [ \begin{matrix}vec ( {N}_{i , j} ) \\ vec ( {N}_{j , i}^{T} )\end{matrix} ] .$$

Based on this signal model, estimators for the calibration coefficients cⱼ and cᵢ can be constructed via a maximum likelihood cost function (equivalent to minimizing the squared residuals):

$${J}_{ML} ( {E}_{i , j} , {c}_{i , j} ) = {‖ [ \begin{matrix}vec ( {Y}_{i , j} ) \\ vec ( {Y}_{j , i}^{T} )\end{matrix} ] - [ \begin{matrix}{E}_{i , j} & 0 \\ 0 & {E}_{i , j}\end{matrix} ] {c}_{i , j} ‖}^{2}$$

where

$${c}_{i , j} = [ \begin{matrix}{c}_{j} \\ {c}_{i}\end{matrix} ] .$$

To estimate the calibration coefficients, the values of E_{i,j} and c_{i,j} that minimize J_{ML}(E_{i,j}, c_{i,j}) may be sought. However, there is no obvious closed-form solution for this problem since the cost function is not quadratic on the joint parameter space of E_{i,j} and c_{i,j}. One approach for solving the problem is to let one part of the parameter space (e.g., E_{i,j}) be temporarily fixed and use a closed-form solution for the remaining part of the parameter space (e.g., c_{i,j}):

$${\hat{c}}_{i , j} = {[ \begin{matrix}{E}_{i , j} & 0 \\ 0 & {E}_{i , j}\end{matrix} ]}^{†} [ \begin{matrix}vec ( {Y}_{i , j} ) \\ vec ( {Y}_{j , i}^{T} )\end{matrix} ]$$

where A^{†} denotes the Moore-Penrose inverse of A. Then alternating minimization may be used to find estimates for E_{i,j} and c_{i,j}. More specifically, letting the estimates obtained at the n^{th} iteration of the alternation be given by ĉ_{i,j}⁽ⁿ⁾ and Ê_{i,j}⁽ⁿ⁾, the estimates at iteration n+1 may be obtained as:

$${\hat{c}}_{i , j}^{( n + 1 )} = {[ \begin{matrix}{\hat{E}}_{i , j}^{( n )} & 0 \\ 0 & {\hat{E}}_{i , j}^{( n )}\end{matrix} ]}^{†} [ \begin{matrix}vec ( {Y}_{i , j} ) \\ vec ( {Y}_{j , i}^{T} )\end{matrix} ] and {\hat{E}}_{i , j}^{( n + 1 )} = {[ \begin{matrix}diag ( {\hat{c}}_{i}^{( n + 1 )} , … , {\hat{c}}_{i}^{( n + 1 )} ) \\ diag ( {\hat{c}}_{j}^{( n + 1 )} , … , {\hat{c}}_{j}^{( n + 1 )} )\end{matrix} ]}^{†} [ \begin{matrix}vec ( {Y}_{i , j} ) \\ vec ( {Y}_{j , i}^{T} )\end{matrix} ]$$

Where diag (cⱼ⁽ⁿ⁺¹⁾, . . . , cⱼ⁽ⁿ⁺¹⁾) is a diagonal matrix with cⱼ⁽ⁿ⁺¹⁾ in the main diagonal.

It can be shown that J_{ML} (Ê_{i,j}⁽ⁿ⁾, c_{i,j}⁽ⁿ⁾)≥J_{ML}(Ē_{i,j}⁽ⁿ⁺¹⁾, c_{i,j}⁽ⁿ⁺¹⁾). Thus, the iterative alternating procedure converges at least to a local optimum.

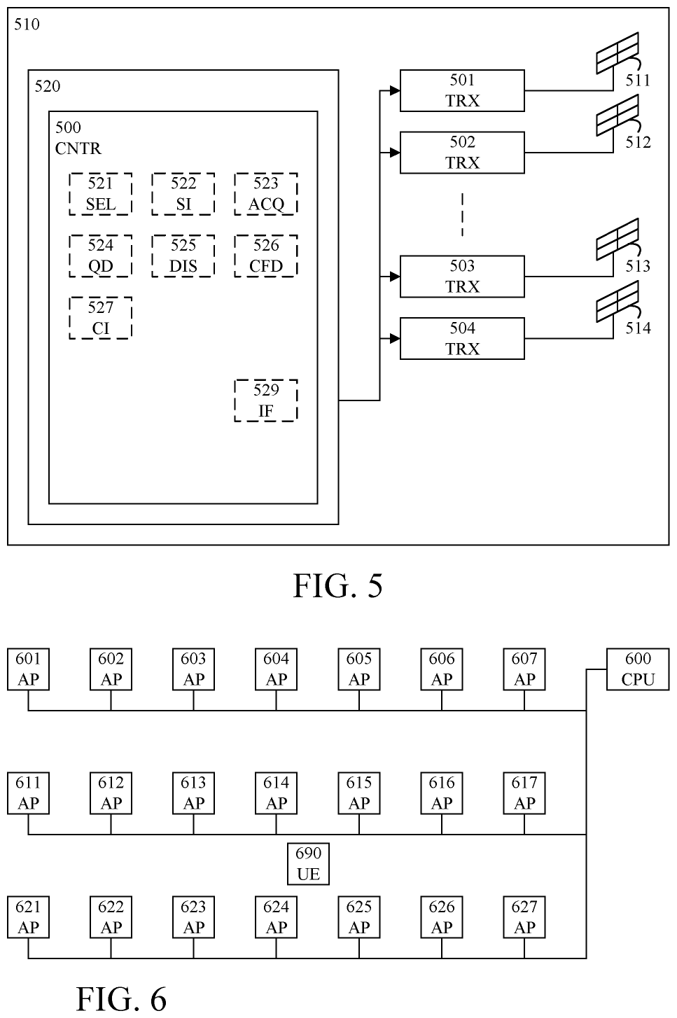

FIG. 5 schematically illustrates an example multi-antenna transceiver system 510 comprising an example apparatus 520 and a plurality of beamforming sub-systems 511, 512, 513, 514 connected to respective transceiver chains (TRX) 501, 502, 503, 504, wherein each beamforming sub-system is associated with a set of available beams.

The multi-antenna transceiver system 510 may be a distributed multiple-input multiple-output (MIMO) system, and each beamforming sub-system may be comprised in an access point of the distributed MIMO system.

The apparatus 520 (which may be a control device, for example) is configured to control over-the-air (OTA) beamforming calibration for the multi-antenna transceiver system 510.

For example, the apparatus 520 may be configured to perform one or more steps of the method 100 of FIG. 1.

The apparatus 520 comprises a controller (CNTR; e.g. controlling circuitry or a control module) 500.

The controller 500 is configured to cause selection of pairs of one transmission beam and one reception beam, wherein the beams of a pair are selected from the set of available beams of different ones of the beamforming sub-systems (compare with 110 of FIG. 1).

To this end, the controller 500 may comprise, or be otherwise associated with (e.g., connected, or connectable, to) a selector (SEL; e.g., selecting circuitry or a selection module) 521. The selector 521 may be configured to select the pairs of one transmission beam and one reception beam, wherein the beams of a pair are selected from the set of available beams of different ones of the beamforming sub-systems.

The controller 500 is also configured to cause instruction of the beamforming sub-systems to use each selected pair of one transmission beam and one reception beam for sounding signal measurements in a respective measurement resource (compare with 120 of FIG. 1).

To this end, the controller 500 may comprise, or be otherwise associated with (e.g., connected, or connectable, to) a sounding instructor (SI; e.g., sounding instructing circuitry or a sounding instruction module) 522. The sounding instructor 522 may be configured to instruct the beamforming sub-systems to use each selected pair of one transmission beam and one reception beam for sounding signal measurements in a respective measurement resource. For example, the sounding instructor 522 may comprise, or be otherwise associated with (e.g., connected, or connectable, to) an interface (IF) 529 configured to transmit a control signal indicative of the instruction to the beamforming sub-systems.

The controller 500 may also be configured to cause acquisition of measurement reports from the beamforming sub-systems, wherein the measurement reports indicate quality of the sounding signal measurements (compare with 130 of FIG. 1).

To this end, the controller 500 may comprise, or be otherwise associated with (e.g., connected, or connectable, to) an acquirer (ACQ; e.g., acquiring circuitry or an acquisition module) 523. The acquirer 523 may be configured to acquire the measurement reports from the beamforming sub-systems, wherein the measurement reports indicate quality of the sounding signal measurements. For example, the acquirer 523 may comprise, or be otherwise associated with (e.g., connected, or connectable, to) the interface (IF) 529 configured to receive the measurement reports from the beamforming sub-systems.

The controller 500 may also be configured to cause determination of whether the sounding signal measurements meet a measurement quality criterion for all beamforming sub-systems (compare with 140 of FIG. 1).

To this end, the controller 500 may comprise, or be otherwise associated with (e.g., connected, or connectable, to) an quality determiner (QD; e.g., quality determining circuitry or a quality determination module) 524. The quality determiner 524 may be configured to determine whether the sounding signal measurements meet a measurement quality criterion for all beamforming sub-systems.

The controller 500 may also be configured to cause discontinuation of the sounding signal measurements responsive to the sounding signal measurements meeting the measurement quality criterion for all beamforming sub-systems (compare with 150 of FIG. 1).

To this end, the controller 500 may comprise, or be otherwise associated with (e.g., connected, or connectable, to) a discontinuer (DIS; e.g., discontinuing circuitry or a discontinuation module) 525. The discontinuer 525 may be configured to discontinue the sounding signal measurements responsive to the sounding signal measurements meeting the measurement quality criterion for all beamforming sub-systems. For example, the discontinuer 525 may comprise, or be otherwise associated with (e.g., connected, or connectable, to) the interface (IF) 529 configured to transmit a control signal indicative of the discontinuation to the beamforming sub-systems.

The controller 500 may also be configured to cause determination of respective beamforming calibration factors for the transceiver chains based on the sounding signal measurements (compare with 160 of FIG. 1).

To this end, the controller 500 may comprise, or be otherwise associated with (e.g., connected, or connectable, to) a calibration factor determiner (CFD; e.g., calibration factor determining circuitry or a calibration factor determination module) 526. The calibration factor determiner 526 may be configured to determine respective beamforming calibration factors for the transceiver chains based on the sounding signal measurements.

The controller 500 may also be configured to cause instruction of one or more of the beamforming sub-systems to transmit a beamformed communication signal based on reverse channel estimation and the determined beamforming calibration factors (compare with 170 of FIG. 1).

To this end, the controller 500 may comprise, or be otherwise associated with (e.g., connected, or connectable, to) a communication instructor (CI; e.g., communication instructing circuitry or a communication instruction module) 527. The communication instructor 527 may be configured to instruct one or more of the beamforming sub-systems to transmit a beamformed communication signal based on reverse channel estimation and the determined beamforming calibration factors. For example, the communication instructor 527 may comprise, or be otherwise associated with (e.g., connected, or connectable, to) the interface (IF) 529 configured to transmit a control signal indicative of the instruction to the beamforming sub-systems.

FIG. 6 schematically illustrates an example scenario in relation to some embodiments. The example scenario is a distributed MIMO system. The distributed MIMO system comprises a central processing unit (CPU) 600 and a plurality of access points (SP) 601, 602, 603, 604, 605, 606, 607, 611, 612, 613, 614, 615, 616, 617, 621, 622, 623, 624, 625, 626, 627, and may be configured to communicate with one or more user equipments (UE) 690 using Joint beamforming at the APs.

For example, the distributed MIMO system of FIG. 6 may correspond to the multi-antenna transceiver system 510 of FIG. 5. Then, the CPU 600 may correspond to (or comprise) the apparatus 520, and each AP 601, . . . , 627 may correspond to (or comprise) a beamforming sub-system 511, 512, 513, 514 and/or a transceiver chain (TRX) 501, 502, 503, 504.

The CPU 600 is configured to control over-the-air (OTA) beamforming calibration for the distributed MIMO system. For example, the CPU 600 may be configured to perform one or more steps of the method 100 of FIG. 1.

The CPU 600 is configured to cause selection of pairs of one transmission beam and one reception beam, wherein the beams of a pair are selected from the set of available beams of different ones of the APs (compare with 110 of FIG. 1).

The CPU 600 is also configured to cause instruction of the APs to use each selected pair of one transmission beam and one reception beam for sounding signal measurements in a respective measurement resource (compare with 120 of FIG. 1).

The CPU 600 may also be configured to cause acquisition of measurement reports from the APs, wherein the measurement reports indicate quality of the sounding signal measurements (compare with 130 of FIG. 1).

The CPU 600 may also be configured to cause determination of whether the sounding signal measurements meet a measurement quality criterion (compare with 140 of FIG. 1).

The CPU 600 may also be configured to cause discontinuation of the sounding signal measurements responsive to the sounding signal measurements meeting the measurement quality criterion (compare with 150 of FIG. 1).

The CPU 600 may also be configured to cause determination of respective beamforming calibration factors for the APs based on the sounding signal measurements (compare with 160 of FIG. 1).

The CPU 600 may also be configured to cause instruction of one or more of the APs to transmit a beamformed communication signal (e.g., to the UE 690) based on the determined beamforming calibration factors (compare with 170 of FIG. 1).

It should be noted that features described in connection with FIG. 5 may be equally applicable in relation to FIG. 6, even if not explicitly mentioned in connection thereto.

It should also be noted that features described earlier herein (e.g., in connection with FIG. 1 or 2) may be equally applicable in relation to FIGS. 5 and/or 6, even if not explicitly mentioned in connection thereto.

Simulations have been conducted to illustrate results achievable by application of various embodiments. For simplicity, the case of calibrating two APs have been simulated, wherein each AP has two antennas and two possible DFT beams. Thus, the transmit and receive beamforming codebooks are DFT matrices of size 2×2 and the codebooks satisfy Bⱼ=Bᵢ=Fⱼ=Fᵢ. The gains of the transmitter chains (t₁^{AP} and t₂^{AP}) and the gains of the receiver chains (r₁^{AP} and r₂^{AP}) are independent and identically distributed (i.i.d.) unit-length phasors with uniform phase distribution across [0,2π[. The non-diagonal entries of the symmetric propagation channel matrix H_{c} are i.i.d. zero-mean unit-variance circularly symmetric complex-valued Gaussian variables, the non-diagonal entries of the additive receiver noise matrices, N_{i,j} and N_{j,i}, are i.i.d. zero-mean circularly symmetric complex-valued Gaussian variables with variance σ², and the calibration signal-to-noise ratio (SNR) is defined as σ⁻². The maximum likelihood (ML) based alternating algorithm disclosed earlier herein is used to process the measurements and estimate the calibration matrix C=diag{c}, with calibration vector c=[c₁, . . . c_{M}]^{T}.

When the calibration coefficients are applied is in the context of (reciprocity-based) beamforming, any scaled version of a calibration vector is equally good in terms of beamforming performance (since only the complex amplitude differences between antenna elements are relevant for beamforming; not the absolute values of the amplitudes of each antenna element). Thus, the vector estimate ĉ is as good as the vector αĉ, where α is any non-zero complex number. Thus, a suitable calibration performance error metric is one minus the cosine of the principal angle between the subspace spanned by the true coefficient vector c and the subspace spanned by the vector estimate ĉ. This error metric (or alignment error) can be written as

$$1 - \frac{{c}^{H} \hat{c}}{\sqrt{{c}^{H} c {\hat{c}}^{H} \hat{c}}} .$$

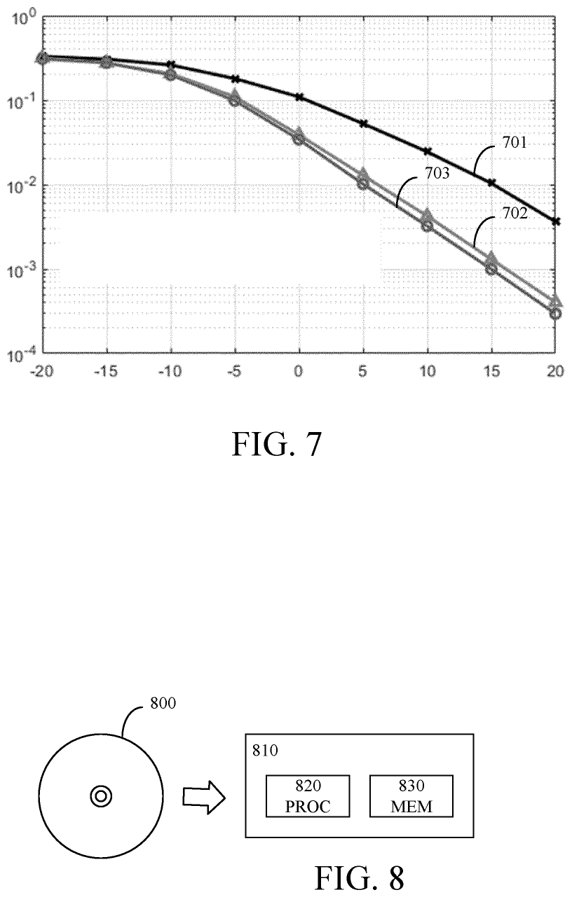

FIG. 7 is a simulation plot illustrating example results achievable by some embodiments. The x-axis shows SNR in dB and the y-axis shows average alignment error. The result of using a set of arbitrary measurements for calibration is shown as 701. This represents an application of an existing calibration scheme in the context of cell-free massive MIMO; using only one measurement for each AP pair, where transmission and receiver beams are picked at random with equal probability. The result of using a set of measurements with the strongest beams for calibration is shown as 702. This represents using only one measurement for each AP pair, where transmission and receiver beams that maximize the link budget are used. The result of using a set of all possible measurements for calibration is shown as 703. This represents using several measurements for each AP pair, where all combinations of transmission and receiver beams are considered.

Since the average alignment error decreases with increasing SNR, the curves indicate that the applied over-the-air approaches represent a viable option to estimate calibration coefficients when the link conditions between APs are favorable.

The gap between 701 and 702 shows that using the beams that yield the strongest measurement for calibration is better than using arbitrary beams. This gap can be significant, which shows that it may be important to find suitable beam pairs for calibration.

The gap between 702 and 703, is less significant but still evident. This gap represents what the measurements associated with beam pairs other than that yielding the highest link budget contribute to the calibration. This shows that, if measurements for beam pairs other than that yielding the highest link budget are available, it may be beneficial to use them for calibration as well as the measurements for beam pairs that yield the highest link budget.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a control device for a multi-antenna transceiver system.

Embodiments may appear within an electronic apparatus (such as a control device for a multi-antenna transceiver system) comprising arrangements, circuitry, and/or logic according to any of the embodiments described herein. Alternatively or additionally, an electronic apparatus (such as a control device for a multi-antenna transceiver system) may be configured to perform methods according to any of the embodiments described herein.

According to some embodiments, a computer program product comprises a tangible, or non-tangible, computer readable medium such as, for example a universal serial bus (USB) memory, a plug-in card, an embedded drive or a read only memory (ROM). FIG. 8 illustrates an example computer readable medium in the form of a compact disc (CD) ROM 800. The computer readable medium has stored thereon a computer program comprising program instructions. The computer program is loadable into a data processor (PROC; e.g., data processing circuitry or a data processing unit) 820, which may, for example, be comprised in a control device for a multi-antenna transceiver system 810. When loaded into the data processor, the computer program may be stored in a memory (MEM) 830 associated with or comprised in the data processor. According to some embodiments, the computer program may, when loaded into and run by the data processor, cause execution of method steps according to, for example, any of the methods described herein illustrated (e.g., the method 100 of FIG. 1).

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A method of controlling over-the-air beamforming calibration for a multi-antenna transceiver system having a plurality of beamforming sub-systems connected to respective transceiver chains, wherein each beamforming sub-system is comprised in an access point of a distributed multiple-input multiple-output (MIMO) system, and wherein each beamforming sub-system is associated with a set of available beams, the method comprising:
selecting pairs of one transmission beam and one reception beam, wherein a pair of the one transmission beam and the one reception beam are selected from the set of available beams of different ones of the beamforming sub-systems; and
instructing the beamforming sub-systems to use each selected pair of the one transmission beam and the one reception beam for sounding signal measurements in a respective measurement resource.

2. The method of claim 1, wherein selecting pairs of the one transmission beam and the one reception beam comprises selecting all possible pairs for the plurality of beamforming sub-systems.

3. The method of claim 1, wherein selecting pairs of the one transmission beam and the one reception beam comprises selecting less than all possible pairs for the plurality of beamforming sub-systems.

4. The method of claim 3, wherein the selected pairs comprise at least one transmission beam per beamforming sub-system.

5. The method of claim 1, wherein the selected pairs comprise at least one reception beam per beamforming sub-system for each selected transmission beam.

6. The method of claim 3, wherein the selected pairs comprise beam pairs previously providing sounding signal measurements that meet a first measurement quality criterion.

7. The method of claim 1, wherein selecting pairs of the one transmission beam and the one reception beam comprises selecting a first set of pairs and selecting at least a second set of pairs, wherein instructing the beamforming sub-systems comprises instructing the beamforming sub-systems to use each selected pair of the first set for sounding signal measurements in a collection of first respective measurement resources and instructing the beamforming sub-systems to use each selected pair of the second set for sounding signal measurements in a collection of second respective measurement resources, and wherein the collection of second respective measurement resources occurs later in time than the collection of first respective measurement resources.

8. The method of claim 7, wherein beams of the first set of pairs are wider than beams of the second set of pairs.

9. The method of claim 1, further comprising acquiring measurement reports from the beamforming sub-systems, wherein the measurement reports indicate quality of the sounding signal measurements.

10. The method of claim 1, further comprising discontinuing the sounding signal measurements when the sounding signal measurements meet a second measurement quality criterion for all beamforming sub-systems.

11. The method of claim 1, further comprising determining respective beamforming calibration factors for the transceiver chains based on the sounding signal measurements.

12. The method of claim 11, further comprising instructing one or more of the beamforming sub-systems to transmit a beamformed communication signal based on reverse channel estimation and the determined beamforming calibration factors.

13. The method of claim 11, wherein each beamforming calibration factor represents a ratio between receiver path gain and transmitter path gain for a corresponding transceiver chain or a ratio between transmitter path gain and receiver path gain for a corresponding transceiver chain.

14. The method of claim 11, wherein determining respective beamforming calibration factors comprises performing joint iterative minimization, and wherein each iteration comprises updating estimates for the beamforming calibration factors based on a calibration nuisance estimate of a previous iteration, and updating the calibration nuisance estimate based on the updated estimates for the beamforming calibration factors.

15. The method of claim 1, wherein the over-the-air beamforming calibration is for providing a calibrated baseband-to-baseband channel that is closer to reciprocal with an un-calibrated baseband-to-baseband opposite direction channel than an un-calibrated baseband-to-baseband channel.

16. The method of claim 1, wherein each beamforming sub-system is connected to a number of transceiver chains, and wherein the number of transceiver chains is less than a number of antenna elements of the beamforming sub-system.

17. The method of claim 1, wherein each beamforming sub-system is connected to a single transceiver chain.

18. (canceled)

19. An apparatus configured to control over-the-air beamforming calibration for a multi-antenna transceiver system having a plurality of beamforming sub-systems connected to respective transceiver chains, wherein each beamforming sub-system is comprised in an access point of a distributed multiple-input multiple-output (MIMO) system, and wherein each beamforming sub-system is associated with a set of available beams, the apparatus comprising controlling circuitry configured to cause:
selection of pairs of one transmission beam and one reception beam, wherein a pair of the one transmission beam and the one reception beam are selected from the set of available beams of different ones of the beamforming sub-systems; and
instruction of the beamforming sub-systems to use each selected pair of the one transmission beam and the one reception beam for sounding signal measurements in a respective measurement resource.

20-39. (canceled)
